(19) United States
(12) Patent Application Publication
(10) Pub. No.: US 2007/0096473 A1
(43) Pub. Date: May 3, 2007

(54) Shipping-container door handle extender

(76) Inventor: Vincent C. Ortega, Whittier, CA (US)

Correspondence Address: AVERILL & VARN, 8244 PAINTER AVE., WHITTIER, CA, 90602, US

(21) Appl. No.: 11/265,673

(22) Filed: Nov. 1, 2005

(51) Int. Cl. E05C 21/00

(52) U.S. Cl. 292/1

(57) ABSTRACT

A door handle extender for a shipping-container, a dry freight unit, or a refrigerator unit. The door handle is attached to a vertical locking bar which is rotated to hook and to unhook latches residing at the top and bottom of the shipping-container door. The latches engage locking housings attached to the shipping-container to lock the doors. The door handle extender comprises an offset arm with a grasping portion at one end and an engaging portion at an opposite end. The engaging portion includes a door handle mouth for sliding over the door handle. The door handle mouth is sized and shaped to nonrotatingly engage the door handle. The grasping portion includes a soft covering and allows a two handed grip. The door handle extender is offset to clear an adjacent vertical bar and may further include a notch to engage a fifthwheel release handle to facilitate releasing a trailer.

### BACKGROUND OF THE INVENTION

The present invention relates to handle extenders and in particular to a handle extender for sliding over a shipping-container door handle to provide improved leverage and an improved grip.

Large shipping-containers are generally used to facilitate shipping by ship, rail, and truck. The containers are stacked in and on container ships, and the same container may be loaded onto suitable rail cars for movement over rail lines, and onto trailers pulled by trucks on the highways. Such containers generally have side by side doors in the rear of the trailer. The doors are held closed by vertical bars running between latches at the top and bottom of the doors, and each door may have one or two vertical bars and associated latches. The latches are operated by rotating the vertical bars using a handle mounted to the vertical bars.

The container door handle is fairly short and is difficult to grasp with more than one hand. The handles may operate fairly easily on a new door, but as the latches wear, and metal becomes corroded, the handles often become difficult to operate. Further, in harsh and/or cold weather, the operator may need to wear gloves, and it may be even more difficult to grasp and operate the door handles. As a result, truck drivers rely on various tools to assist in moving the door handles, for example, ball pins hammers, crowbars, large Crescent wrenches, blocks of wood, or very large screwdrivers. Because such tools were designed for different application, in some cases the missuse of such tools results in a variety of injuries to the drivers. Such as broken or bruised fingers, broken hand bones, sprained or broken wrists or arms, or various injuries to the shoulders or back.

Additionally, releasing a trailer requires operating a fifthwheel release latch. The fifthwheel latch generally includes a small handle located close to the trailer plate. The trailer plate is generally heavily coated with grease to avoid metal to metal contact between the fifthwheel and trailer, and the fifthwheel latch handle may become both slippery and dirty as a result.

Thus, a need remains for a tool designed specifically for container door handles, which tool address the issues of safety and safe operation of opening and closing container doors with injury or other mishap, and which improves productive.

### BRIEF SUMMARY OF THE INVENTION

The present invention addresses the above and other needs by providing a door handle extender for a shipping-container (also known as a dismountable cargo container), a dry freight unit, or a refrigerator unit. The door handle is attached to a vertical locking bar which is rotated to hook and to unhook latches residing at the top and bottom of the shipping-container door. The latches engage locking housings attached to the shipping-container to lock the doors. The door handle extender comprises an offset arm with a grasping portion at one end and an engaging portion at an opposite end. The engaging portion includes a substantially oval door handle mouth for sliding over the door handle. The door handle mouth is sized and shaped to nonrotatingly engage the door handle. The grasping portion includes a soft covering to allow a firm two handed grip. The door handle extender is offset to clear an adjacent vertical bar and may further include a notch configured to engage a fifthwheel release handle to facilitate releasing a trailer. Similar door handles are used on semitrailers pulled by truck tractors, and the door handle extender is equally suitable for such semitrailers.

In accordance with one aspect of the invention, there is provided a truck trailer tool comprising a door handle extender and a fifthwheel release handle extender. The door handle extender comprises an arm having a first end and a second end opposite the first end, an engaging portion of the arm, the engaging portion proximal to the first end, the engaging portion having a mouth configured to nonrotatingly engage the door handle, and a grasping portion of the arm sufficiently long to allow a two handed side by side grip of the grasping portion. A center portion resides between the engaging portion and the grasping portion. A first bend resides between the engaging portion and the center portion and a second bend resides between the center portion and the grasping end. The grasping portion is substantially parallel to the engaging portion and the center portion is angled to offset the grasping portion from the engaging portion. A fifthwheel handle notch resides proximal to the engaging portion for hooking over a fifthwheel handle to release a trailer.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A is a side view of a tractor and trailer carrying a container.

FIG. 1B is a top view of the tractor and trailer carrying the container.

FIG. 2 is a rear view showing the container on the trailer and including details of container doors.

FIG. 3A is a top view taken along line 3-3 of FIG. 2, showing handles used to hook and unhook container door latches, with the latches hooked and the doors closed.

FIG. 3B is a top view taken along line 3-3 of FIG. 2, showing the handles used to hook and unhook the container door latches, with the latches unhooked and the doors closed.

FIG. 3C is a top view taken along line 3-3 of FIG. 2, showing the handles used to hook and unhook the container door latches, with the latches unhooked and the doors open.

FIG. 4A is a side view of a door handle extender according to the present invention.

FIG. 4B is a top view of the door handle extender according to the present invention.

FIG. 4C is an end view of the door handle extender according to the present invention.

FIG. 4D is a cross-sectional view taken along line 4D-4D of FIG. 4A of a loop attached to the door handle extender.

FIG. 5 shows an engaging portion of the door handle extender, a center portion of the door handle extender, and a grasping portion of the door handle extender.

FIG. 6 shows a trailer door with the door handle extender engaging a handle.

FIG. 7A is a top view of the door handle extender engaging a handle with the handle in the hooked position.

FIG. 7B is a top view of the door handle extender engaging a handle with the handle in the unhooked position.

FIG. 8A is a top view of a tractor showing a trailer plate.

FIG. 8B is a top view of the tractor showing the door handle extender engaging a fifthwheel handle attached to the trailer plate.

FIG. 9 is a method according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

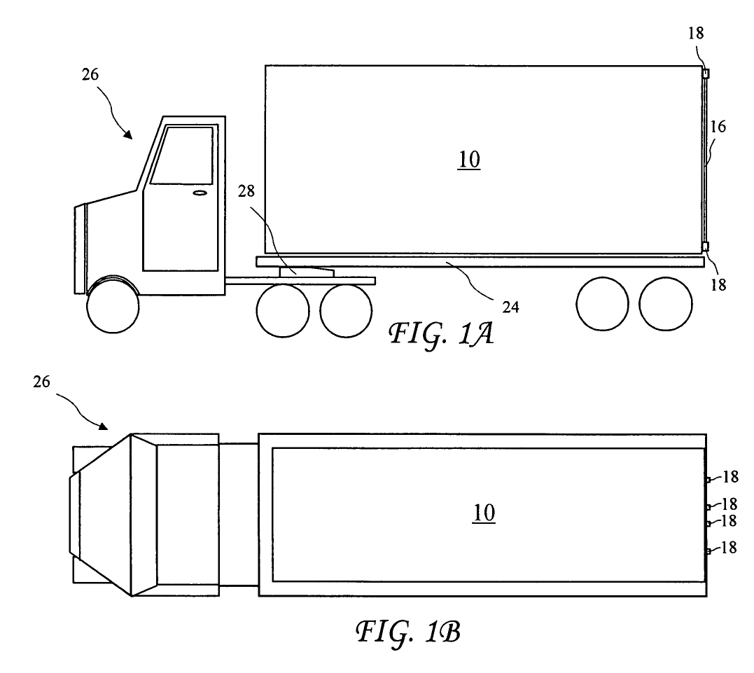

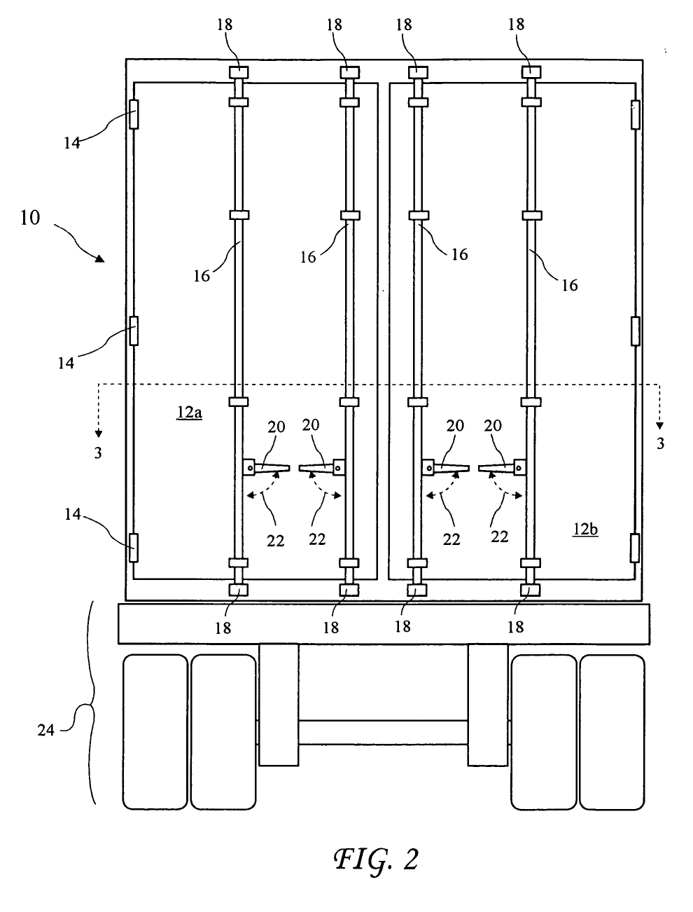

A side view of a tractor 26 and trailer 24 carrying a container 10 is shown in FIG. 1A, and a is a top view of the tractor 26 and trailer 24 carrying the container 10 is shown in FIG. 1B. The forward end of the trailer 10 is supported by a trailer plate 28 attached to the tractor 26. Doors 12a and 12b (see FIG. 2) at a rearward end of the container 10 are held closed by latches 18 at the tops and bottoms of the doors 12a and 12b, and the latches 18 may be hooked and unhooked by vertical bars 16.

A rear view showing the container 10 on the trailer 24 and including details of the container doors 12a and 12b is shown in FIG. 2. The doors 12a and 12b are generally connected to the trailer 24 by hinges 14 along the outside edges of the doors 12a and 12b. The doors 12a and 12b are held in a closed position by latches 18 at the tops and bottoms of the doors. The latches 18 are attached to vertical bars 16, and the vertical bars 16 may be rotated by handles 20 to hook the latches 18 to hold the doors 12a and 12b closed, and the vertical bars 16 may be rotated by handles 20 to unhook the latches 18 to release the doors 12a and 12b for opening. Common containers 10 include a pair of vertical bars 16 and four latches 18 on each door. The handles 20 generally may be rotated along a first arc 22 to fold the handles 20 against the vertical bars 16.

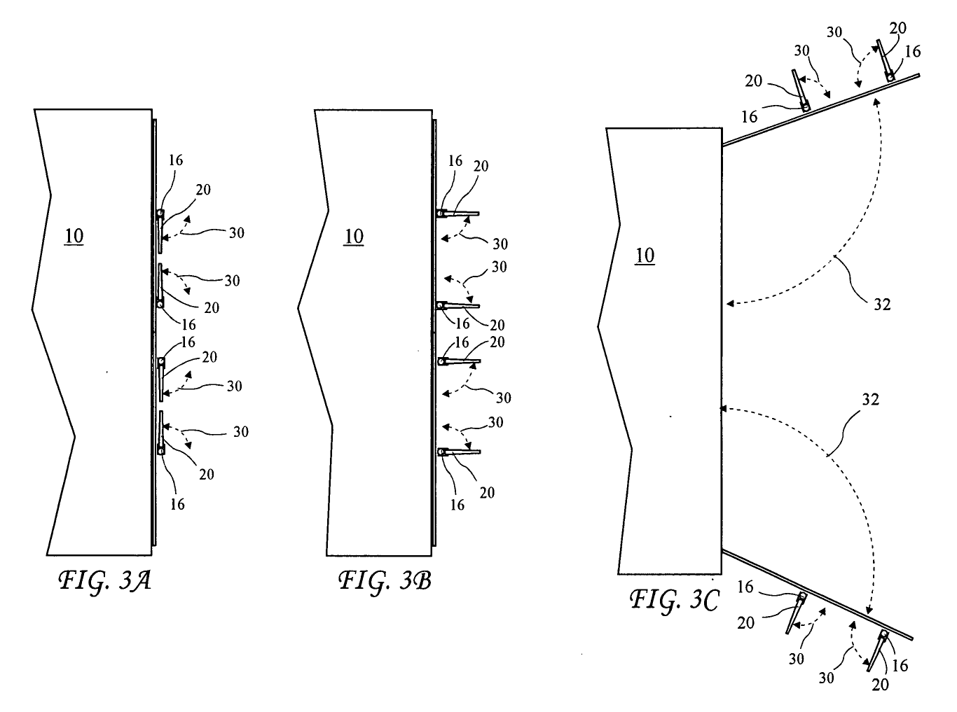

A top view taken along line 3-3 of FIG. 2, showing handles 20 positioned corresponding to the latches 18 (see FIG. 2) hooked, and the doors 12a and 12b closed is shown in FIG. 3A, a top view taken along line 3-3 of FIG. 2, showing the handles 20 positioned corresponding to the latches 18 unhooked, and the doors 12a and 12b closed is shown in FIG. 3B, and a top view taken along line 3-3 of FIG. 2, showing the handles 20 positioned corresponding to the latches 18 unhooked, and the doors 12a and 12b open is shown in FIG. 3C. The handles 20 are rotated along a second arc 30 to rotate the vertical bars 16 (see FIG. 2) between the hooked and unhooked positions. Unfortunately, the handles 20 are fairly short to fit in the allowable space. As containers age, become corroded, or damaged, the vertical bars 16 and/or latch 18 often become difficult to operate. Truck drivers are known to use hammers, and other potentially damaging objects, to rotate the handles 20. Further, soiled, icy, or wet handles may be very difficult to grasp. No tool is presently available to easily overcome these difficulties.

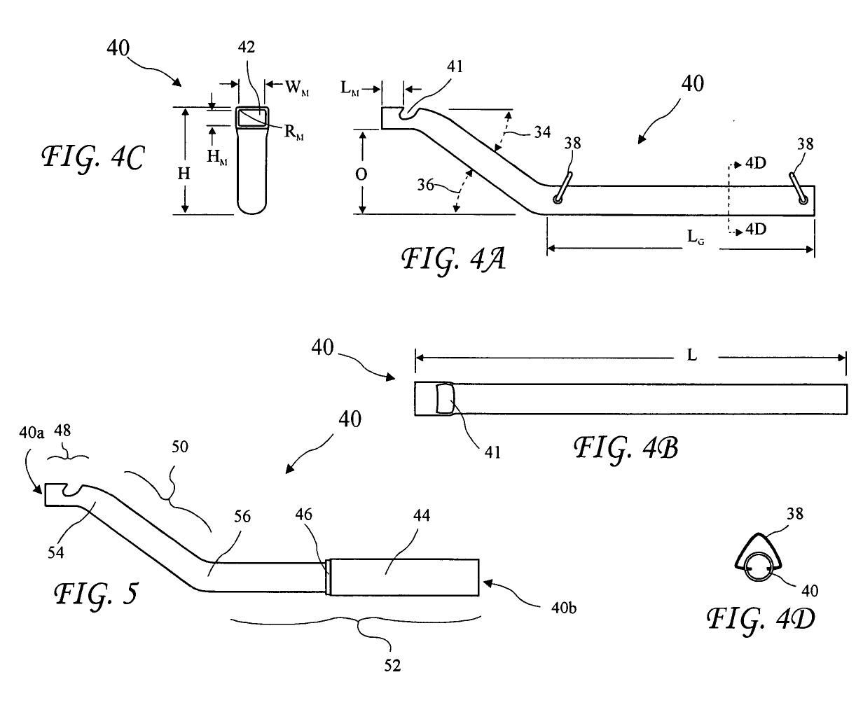

A side view of a door handle extender 40 according to the present invention is shown in FIG. 4A, a top view of the door handle extender 40 is shown in FIG. 4B, and an end view of the door handle extender 40 is shown in FIG. 4C. An engaging portion 48, a center portion 50, and a grasping portion 52 of the door handle extender 40 are shown in FIG. 5. The door handle extender 40 has an overall length L, and an overall height H. The length L is preferably between approximately 18 inches and approximately 28 inches, and the length L is more preferably is approximately 20.75 inches, and the height H is preferably between approximately three inches and approximately seven inches, and more preferably approximately to five inches. The engaging portion 48 preferably includes a substantially straight section with a length L_{M} running to a first end 40a of the door handle extender 40, which length L_{M} is preferably approximately ½ inches to approximately three inches, and more preferably approximately two inch. The grasping portion 52 preferably comprises a substantially straight length L_{G} running to a second end 40b of the door handle extender 40, wherein the length L_{G} is preferably between approximately 10 inches and approximately 20 inches, and more preferably approximately 11.5 inches. The engaging portion 48 need only be substantially straight sufficiently to allow the engaging portion to slide over the handle 20. The grasping portion need only be substantially straight sufficiently to avoid adjacent vertical bars and handles, and to provide space grasping the door handle extender 40. The door handle extender 40 may be made from any suitably strong material, for example, steel, galvanized steel, stainless steel, aluminum, and is preferably made from a commonly available steel pipe or tuning, and is more preferably made from schedule 40 or schedule 80 steel pipe, and most preferably from schedule 40 steel pipe. The door handle extender 40 is further preferably made from ¾ inch, one inch, or 1¼ inch steel pipe, and is more preferably made from one inch steel pipe. The portions 48, 50, and 52 are preferably straight within the normal tolerances of schedule 40 steel pipe.

A first bend 54 between the engaging portion 48 and the center portion 50 is preferably between approximately 15 degrees and approximately 60 degrees, and is more preferably an approximately 35 degree bend, and has an inside radius of approximately 0.25 inches. A second bend 56 between the center portion 50 and the grasping portion 52 is preferably between approximately 15 degrees and approximately 60 degrees, and is more preferably an approximately 35 degree bend, and has an inside radius of approximately 0.25 inches. The bends 54 and 56 are preferably similar angles and the grasping portion 52 is preferably parallel to the engaging portion 48. The door handle extender 40 is offset to avoid hitting an adjacent handle or vertical bar, and to provide space between the door 12a or 12b and the door handle extender 40 to allow a solid grip. The length of the door handle extender 40 provides sufficient leverage to rotate the handles 20, without being so long as to be a nuisance in the truck cab, trunk, or similar storage location.

The engaging portion 48 includes a mouth 42 for cooperating with the handle 20. The mouth has an inside width W_{M} and an inside height H_{M}. The width W_{M} is preferably between approximately 0.35 inches and approximately 1.5 inches and is more preferably approximately 1.29 inches, and the height H_{M} is preferably between approximately 0.35 inches and approximately one inch and is more preferably approximately 0.69 inches. The mouth 42 has inside radii R_{M} of preferably between approximately 0.05 inches and approximately 0.75 inches and is more preferably approximately 0.125 inches. The inside dimensions of the mouth 42 are important to prevent the door handle extender 40 from rotating on the handle 20 during use, while permitting the mouth 42 to fit over common handles 20. The shape of the mouth is preferably formed from common schedule 40 steel pipe using a form fitter hydraulic press, for example, a pinch press. If the door handle extender 40 can rotate excessively, a drivers knuckles may hit the door 12a or 12b when hooking the latches 18. A grip 44 preferably resides on the grasping portion 52 to provide more comfortable use of the door handle extender 40. The grip 44 preferably comprises a textured vinyl over a soft vinyl, for example a soft-tex vinyl grip. The grip may be made with a double dip process and have a rounded end, resulting in a inner smooth vinyl layer and a textured outer vinyl layer. The grip is preferably approximately six inches long and approximately 1.36 inches in outside diameter.

The door handle extender 40 further includes a fifthwheel handle notch 41 for pulling a fifthwheel handle. The notch 41 is angled back at approximately 35 degrees, is approximately ½ inches wide, and is approximately ½ inches deep.

Loops (or “D” rings) 38 attached to the door handle extender 40 are shown in FIG. 1A, and in FIG. 4D a cross-sectional view taken along line 4D-4D of FIG. 4A. The loops 38 may be attached to the door handle extender 40 for attaching a lanyard to carried about a wrist to improve safety.

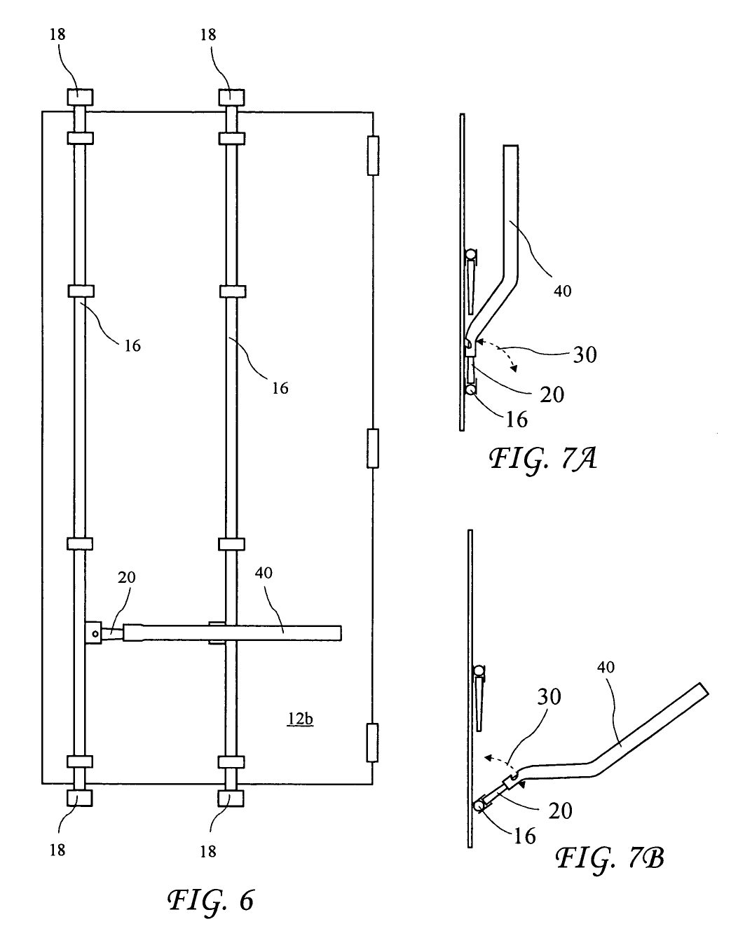

A rear view of the trailer door 12b with the door handle extender 40 engaging a handle 20 is shown in FIG. 6, a top view of the door handle extender 40 engaging a handle 20 with the handle 20 in the hooked position is shown in FIG. 7A, and a top view of the door handle extender 40 engaging the handle 20 with the handle 20 in the unhooked position is shown in FIG. 7B. The door handle extender 40 thus avoids the adjacent vertical bar 18 and handle 20, and provides space for a two handed side by side grasp of the grasping portion 52.

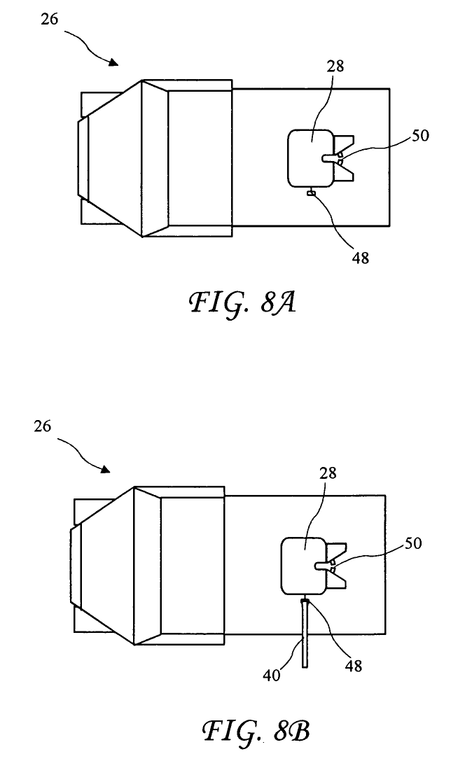

A top view of a tractor 26 including a trailer plate (also called a fifthwheel) 28 is shown in FIG. 8A, and a top view of the tractor 26 showing the door handle extender 40 engaging a fifthwheel handle 48 attached to the trailer plate 28 is shown in FIG. 8B. The handle 48 releases jaws 50 which retain a trailer kingpin in place in the fifthwheel 28. A large amount of grease is applied to the trailer plate 28 to facilitate engagement of the trailer 24 with the tractor 26 and articulation of the tractor/trailer. As a result of the proximity of the fifthwheel handle 48 to the trailer plate 28 and to a bottom nose section of the trailer, it is difficult to pull the fifthwheel handle 48 without become soiled by grease, road grit, etc. Using the door handle extender 40 enables simple, safe, and clean actuation of the fifthwheel handle 48.

The door handle extender 40 is preferredly made from common schedule 40 steel/iron pipe or tubing, seamless or welded. The finished door handle extender 40 preferably includes a rust preventative or inhibitive coating because of expected use in harbor areas and ocean enviroments. More particularly, the door handle extender 40 is preferably finished by chemically cleaning, sand blasting, priming, and painting by powder coating. The priming is preferably with a rust preventive primer.

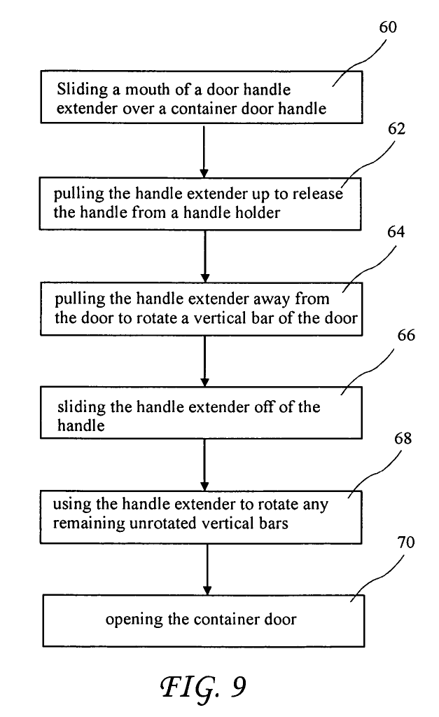

A method according to the present invention is described in FIG. 9. The method includes sliding a mouth of a door handle extender over a container door handle at step 60, pulling the handle extender up to disengage the handle from a handle holder at step 62, pulling the handle extender away from the door to rotate a vertical bar of the door at step 64, sliding the handle extender off of the handle at step 66, using the handle extender to rotate any remaining unrotated vertical bars at step 68, and opening the container door at step 70.

While the invention herein disclosed has been described by means of specific embodiments and applications thereof, numerous modifications and variations could be made thereto by those skilled in the art without departing from the scope of the invention set forth in the claims.

1. A door handle extender for shipping-container, dry freight container, or refrigerator unit doors, comprising:
an arm having a first end and a second end opposite the first end;
an engaging portion of the arm, the engaging portion proximal to the first end;
a mouth at the engaging portion the mouth opening away from the second end, and the mouth having a mouth width _{WE}a mouth height H_{M}, and a mouth length L_{M}, wherein the mouth width _{WE} is greater than the mouth height H_{M} and the mouth width _{WE} and the mouth height H_{M} are configured to allow the mouth to slide over an elongated door handle to nonrotatingly engage the door handle. and wherein the mouth length L_{M} is sufficient to allow enough of the elongated door handle to enter the mouth to communicate torque applied to the second end of the door handle extender to rotate the elongated door handle from a locked to an unlocked position;
a grasping portion of the arm proximal to the second end; and
a lateral offset between the engaging portion and the grasping portion, the lateral offset having at least one bend wherein the lateral offset is in the same direction as the mouth height H_{M} thereby allowing the grasping portion to avoid contact with an adjacent handle or vertical bar and allowing space for a solid grip on the grasping portion.

2. The door handle extender of claim 1, wherein the lateral offset comprises:
a center portion between the engaging portion and the grasping portion;
a first bend between the engaging portion and the center portion; and
a second bend between the center portion and the grasping portion,
wherein the grasping portion is substantially parallel to the engaging portion and the center portion is angled to offset the grasping portion from the engaging portion in the same direction as the mouth height H_{M} ereby allowing the grasping portion to avoid contact with an adjacent handle or vertical bar and allowing space for a solid grip on the grasping portion.

3. The door handle extender of claim 2, wherein:
the arm has a length L of approximately 20.75 inches; and
the engaging portion is offset approximately four inches from the grasping portion in the same direction as the mouth height H_{M} thereby allowing the grasping portion to avoid contact with an adjacent handle or vertical bar and allowing space for a solid grip on the grasping portion.

4. The door handle extender of claim 3,
wherein the mouth length L_{M} is approximately two inches thereby allowing enough of the elongated door handle to enter the mouth to communicate torque applied to the second end of the door handle extender to rotate the elongated door handle from a locked to an unlocked position.

5. The door handle extender of claim 2, wherein:
the first bend is approximately 35 degrees; and
the second bend is approximately 35 degrees.

6. The door handle extender of claim 1, wherein the grasping portion is sufficiently long to permit a two handed side by side grasp.

7-8. (canceled)

9. The door handle extender of claim 2, wherein a first at least one bend begins after and proximal to the mouth.

10. The door handle extender of claim 1, wherein the arm is made from approximately one inch diameter metal tubing.

11. The door handle extender of claim 10, wherein the arm is made from approximately one inch diameter steel tubing.

12. The door handle extender of claim 11, wherein the arm is made from approximately one inch diameter schedule 40 steel tubing.

13. The door handle extender of claim 1, wherein the mouth comprises a straight portion of approximately one inch steel tubing which has been flattened on two opposite sides.

14. The door handle extender of claim 13, wherein the mouth height H_{M} is approximately 0.69 inches and the mouth width _{WE} is approximately 1.29 inches, thereby providing the nonrotating engagement of the mouth with the handle.

15. The door handle extender of claim 1, further including a fifthwheel handle notch for hooking over a fifthwheel handle to release a trailer.

16-20. (canceled)

21. A door handle extender for shipping-container, dry freight container, or refrigerator unit doors, comprising:
an arm having a first end and a second end opposite the first end;
an engaging portion of the arm, the engaging portion proximal to the first end;
a mouth at the engaging portion the mouth opening away from the second end, and the mouth having:
a mouth width _{WE} of approximately 1.29 inches;
a mouth height H_{M} of approximately 0.69 inches; and
a mouth length L_{M} between approximately 0.5 inches and three inches;
a grasping portion of the arm proximal to the second end; and
a lateral offset between the engaging portion and the grasping portion, the lateral offset having at least one bend wherein the lateral offset is in the same direction as the mouth height H_{M} thereby allowing the grasping portion to avoid contact with an adjacent handle or vertical bar and allowing space for a solid grip on the grasping portion.

22. The door handle extender of claim 21, wherein the mouth length L_{M} is approximately two inches.

23. The door handle extender of claim 21, wherein the lateral offset comprises:
a center portion between the engaging portion and the grasping portion;
a first bend between the engaging portion and the center portion; and
a second bend between the center portion and the grasping portion,
wherein the grasping portion is substantially parallel to the engaging portion and the center portion is angled to offset the grasping portion from the engaging portion in the same direction as the mouth height H_{M} thereby allowing the grasping portion to avoid contact with an adjacent handle or vertical bar and allowing space for a solid grip on the grasping portion.

24. The door handle extender of claim 23, wherein an overall height H of the offset is between approximately three inches and approximately seven inches.

25. The door handle extender of claim 23, wherein an overall length L of the door handle extender is between approximately 18 inches and approximately 28 inches.

26. A door handle extender for shipping-container, dry freight container, or refrigerator unit doors, comprising:
an overall length L between approximately 18 inches and approximately 28 inches;
an overall height H in the same direction as a mouth height H_{M}, the height H between approximately three inches and approximately seven inches;
an arm having a first end and a second end opposite the first end;
an engaging portion of the arm, the engaging portion proximal to the first end;
a mouth comprising an open ended passage residing at the engaging portion the mouth opening away from the second end, and the mouth having:
a mouth width _{WE} of approximately 1.29 inches;
the mouth height H_{M} of approximately 0.69 inches; and
a mouth length L_{M} of approximately two inches;
a grasping portion of the arm proximal to the second end; and
a lateral offset portion comprising:
a center portion between the engaging portion and the grasping portion;
a first bend between the engaging portion and the center portion; and
a second bend between the center portion and the grasping portion,
wherein the grasping portion is substantially parallel to the engaging portion and the center portion is angled to offset the grasping portion from the engaging portion in the same direction as the mouth height H_{M} thereby allowing the grasping portion to avoid contact with an adjacent handle or vertical bar and allowing space for a solid grip on the grasping portion.

27. The door handle extender of claim 26, wherein the mouth has a constant cross-section.
